(19) United States
(12) Patent Application Publication
(10) Pub. No.: US 2008/0165097 A1
(43) Pub. Date: Jul. 10, 2008

(54) Large Area LIquid Crystal Display Device

(76) Inventors: David Coates, Wimborne (GB); Amir Ben Shalom, Modiin (IL); Shlomir Engle Dvir, Jerusalem (IL)

Correspondence Address: Pearl Cohen Zedek Latzer, LLP, 1500 Broadway, 12th Floor, New York, NY, 10036, US

(21) Appl. No.: 11/667,481

(22) PCT Filed: Nov. 7, 2005
(86) PCT No.: PCT/GB05/04289

§ 371 Date: Nov. 8, 2007

(30) Foreign Application Priority Data
Nov. 10, 2004 (IL) 165150
Dec. 13, 2004 (GB) 0427299.3

(51) Int. Cl. G09G 3/36

(52) U.S. Cl. 345/87

(57) ABSTRACT

A liquid crystal display device includes at least one cell which provides a rectangular array of addressable pixels having an average area of at least 4 mm². The cell comprises: two substrates (11, 12) defining therebetween a cavity; a layer of liquid crystal material in the cavity; and a respective conductive layer (13, 14) formed on each of the substrates (11, 12). The conductive layers (13, 14) are patterned to provide a rectangular array of separate drive electrodes (51) each capable of driving an area of the layer of liquid crystal material adjacent the respective drive electrode as one of said pixels. The conductive layers (13, 14) also provide a separate track (33) connected to each of the separate drive electrodes (51) and extending to a position outside the array of addressable pixels where the tracks (33) form terminals (34) each capable of receiving a respective drive signal. This allows direct addressing of the pixels. The relatively large size of the pixels allows such direct drive without an unacceptable reduction in the contrast ratio. In addition, the conductive layers may be patterned in a variety of ways to further improve the contrast ratio, e.g. the second conductive layer (14) is patterned to provide a common electrode (72) and a plurality of separate counter electrodes (76). Each respective counter electrode (76) extends over an area opposite one of the gaps (35) between the lines of the electrodes (51).

The present invention relates to a liquid crystal display device including at least one cell which provides a two-dimensional array of addressable pixels for displaying an image. In particular, the present invention relates to the drive arrangement for addressing pixels of a display device having a relatively large area and viewing distance.

The present invention is generally applicable to any type of liquid crystal display apparatus but has particular application to a cholesteric liquid crystal display device which is a type of display device having a low power consumption and a high brightness. A cholesteric liquid crystal display device uses one or more layers of cholesteric liquid crystal material capable of being switched between a plurality of states. These states include a planar state in which the layer of cholesteric liquid crystal material reflects light with wavelengths in a band corresponding to a predetermined colour. In another state, the cholesteric liquid crystal transmits light. A full colour display may be achieved by stacking layers of cholesteric liquid crystal material capable of reflecting red, blue and green light.

There are a number of known drive arrangements for liquid crystal display devices which provide a two-dimensional array of addressable pixels on which an image may be displayed, usually a rectangular array.

Early liquid crystal devices included separate drive electrodes each capable of driving an area of a layer of liquid crystal material adjacent the respective drive electrode and each connected to a separate track capable of receiving a respective drive signal to allow direct addressing of the corresponding area. In this case, the segments are shaped and positioned in a pattern to display a particular image when addressed. A typical example of this is the seven segment display used to display numbers in watches. However such direct addressing was not generally applied to display devices providing a two-dimensional array of addressable pixels. This was because such direct addressing would have the disadvantage of decreasing the contrast ratio as a result of the need to pass a separate track from each one of the drive electrodes to a position outside the array of addressable pixels to form a terminal capable of receiving a drive signal. To accommodate all the tracks, gaps must be left between the pixels which decreases the contrast ratio as the liquid crystal in the gaps is not driven. The problem gets worse as the number of pixels increases.

Thus, other drive arrangements are normally used in liquid crystal display devices providing a two-dimensional array of addressable pixels.

One common drive arrangement is to use passive multiplexed addressing. In this case, the electrodes on each side of the liquid crystal layer are arranged as a set of linear electrodes extending perpendicular to one another. By applying a drive signal between one electrode of each set in a multiplexed manner, the area of the liquid crystal in the overlap between the electrodes of each set may be addressed as a pixel. The problem with passive multiplex addressing is that the drive signal on an electrode intended to drive a given pixel along the electrode can also affect other pixels along the electrode in question. This reduces the electro-optic performance.

Another common drive arrangement is active addressing. In this case, the drive electrodes on one side of the liquid crystal layer are arranged as a two-dimensional array of drive electrodes each capable of driving an adjacent area of the liquid crystal material as a pixel, and each drive electrode is driven by a separate diode or transistor arranged behind or beside the drive electrode. Whilst such active addressing has good electro-optic performance, the display device is difficult and complex to manufacture, typically having a low yield and a high cost, particularly as the number of pixels increases.

The present invention is concerned with the drive arrangement for a liquid crystal display device of relatively large area and viewing distance, for example in which the pixels have an average area of at least 4 mm² or more typically at least 25 mm². Displays of this size are suitable use in many situations, for example outdoors or in public spaces such as buildings or transport terminals.

According to the present invention, there is provided a liquid crystal display device including at least one cell which provides a two-dimensional array of addressable pixels having an average area of at least 4 mm² and comprises:

two substrates defining therebetween a cavity;

a layer of liquid crystal material in the cavity; and

a respective conductive layer formed on each of the substrates, at least one of the conductive layers being patterned to provide:

a two-dimensional array of separate drive electrodes each capable of driving an area of the layer of liquid crystal material adjacent the respective drive electrode as one of said pixels, and a separate track connected to each of the separate drive electrodes and extending to a position outside the array of addressable pixels where the tracks form terminals each capable of receiving a respective drive signal to allow direct addressing of the pixel driven by the drive electrode connected to the respective terminal.

Thus the present invention involves the application of direct addressing of pixels in a liquid crystal display device which provides a two-dimensional array of addressable pixels having a relatively large area. For example, on average the area is at least 4 mm², more usually at least 25 mm². This is instead of applying passive multiplexed addressing or active addressing commonly used in commonly available liquid crystal display devices as discussed above.

The applicability of direct addressing is based on an appreciation that the problem discussed above of the reduction in the contrast ratio brought about by the need to pass a separate track from each one of the drive electrodes to a position outside the array of addressable pixels is less acute for display devices having relatively large pixels. This is for the following reason. The size of the gaps between the pixels needed to accommodate the tracks is fixed for a given number and configuration of drive electrodes and tracks. Thus the fill factor, that is the ratio of the total area of the pixels to the viewing area of the display device including the pixels and the gaps, is reduced as the area of the pixels decreases. This means that the reduction in the contrast ratio caused by the gaps reduces as the size of the pixels increases. It has been appreciated that based on this effect it is possible to achieve acceptable contrast ratios using direct addressing when applied to display devices having relatively large pixels.

Such direct addressing of each pixel is advantageous for a number of reasons. As each pixel can be addressed independently without affecting or influencing the neighbouring pixels in the manner which occurs with passive multiplexed addressing. Thus direct addressing improves the electro-optic performance of the liquid crystal as compared to passive multiplexed addressing. Furthermore, as compared to active addressing, direct addressing is cheaper and simpler to implement because it simply involves appropriate patterning of the conductive layers without the need to include any additional active components such as diodes or transistors. Also direct addressing allows compensation of non-uniformity in the parameters of the cell over the area of the display device, for example variation in thickness of the liquid crystal layer due to the manufacturing process, or temperature variation across the display device. Each pixel can be driven with a drive signal adapted, for example by varying parameters such as voltage or pulse time to compensate those variations.

Typically the two-dimensional array of addressable pixels is a rectangular array (which includes a square array), but in general it may be any array, that is in which the pixels are arranged regularly in two-dimensions. For example, one alternative to a rectangular array is a hexagonal.

The present invention has particular application to a cholesteric liquid crystal display device in which the liquid crystal material is cholesteric liquid crystal material, but may also be applied to other types of liquid crystal display device.

In addition, it has been appreciated that it is possible to select the pattern of the conductive layers forming the electrodes and the tracks to further increase the fill factor and hence the contrast ratio, as compared to the use of a two-dimensional array of identical drive electrodes provided in the conductive layer on one side of the liquid crystal layer. Some particular techniques are as follows.

In accordance with a first technique for improving the contrast ratio, the drive electrodes have gaps therebetween through which the tracks extend, and, across at least part of the array of drive electrodes, successive drive electrodes from the outside of the array of drive electrodes have increasing sizes such that the gaps get thinner as the number of tracks passing through the gaps gets smaller. For example, in respect of at least one line of drive electrodes in the array of drive electrodes, the track connected to each drive electrode in the said line of drive electrodes extends between the said line of drive electrodes and one of the adjacent lines of drive electrodes; and along at least part of the said line of drive electrodes, the tracks connected to the drive electrodes exit the array of drive electrodes on the same side thereof and successive drive electrodes from that side of the array of drive electrodes have successively increasing widths as the number of tracks connected to more distant drive electrodes gets smaller.

Thus in this first technique, the drive electrodes and hence the pixels have differing sizes. The pixels are made larger as the number of tracks passing the pixels gets smaller. In this way, the pixels cover more area than if the gaps were of a constant size across the array of pixels. Thus, as compared to the use of pixels of constant size, the fill factor and hence the contrast ratio is improved. Variation in the area of the pixel does cause a corresponding variation in the brightness of the pixel for a given drive signal. However, it has been appreciated that this variation does not cause a significant degradation in the quality of the image perceived by a viewer because of the physiological effect that the eye perceives brightness on a logarithmic scale and so the effect of the variation in area is limited.

In accordance with a second technique for improving the contrast ratio, the two conductive layers are patterned to provide:

successive lines of the drive electrodes in the array of drive electrodes alternately in the two conductive layers; and

common electrodes in each conductive layer opposite respective lines of drive electrodes provided in the other conductive layer, the common electrodes being arranged within each conductive layer alternately with the lines of drive electrodes provided in the same conductive layer to leave gaps between the lines of drive electrodes and the adjacent common electrodes, the gaps in the two conductive layers being opposite one another; and

the tracks connected to the drive electrodes of respective lines of drive electrodes extending along the said gaps.

This arrangement of electrodes differs from the typical arrangement of one conductive layer being patterned to provide all the drive electrode and the other conductive layer being patterned to provide a single common electrode extending over an area opposite all the drive electrodes. Instead, the drive electrodes are provided in lines which are formed alternately in the two conductive layers. Common electrodes are provided opposite each line of drive electrodes. The tracks are provided in the gaps between the common electrodes and the lines of electrodes in each layer. As a result of arranging the gaps in each conductive layer opposite one another, it is possible for the tracks to be arranged opposite one another also. Effectively this means that the size of the gaps can be reduced as each gap, as viewed from the front of the display, accommodates two sets of tracks, one from each of the lines of drive electrodes adjacent the gap in question. This improves the fill factor and hence the contrast ratio.

In accordance with a third technique for improving the contrast ratio, in respect of at least one line of drive electrodes in the array of drive electrodes, the tracks connected to each drive electrode along a part of the line of drive electrodes extend along a gap between the said line of drive electrodes and an adjacent line of drive electrodes to exit the array of drive electrodes on the one side thereof and the tracks connected to each drive electrode along the remainder of the line of drive electrodes extend along a gap between the said line of drive electrodes and an adjacent line of drive electrodes to exit the array of drive electrodes on the opposite side thereof.

As a result, the tracks from a line of drive electrodes exit the array of drive electrodes on both sides. This means that the number of tracks passing between the lines of drive electrodes is on average reduced. As a result, it is possible to reduce the size of the gaps needed to accommodate the tracks. This improves the fill factor and hence the contrast ratio.

In accordance with a fourth technique for improving the contrast ratio, one of the conductive layers is patterned to provide the drive electrodes and the tracks and the other of the conductive layers is patterned to provide:

at least one common electrode extending over an area opposite a plurality of the drive electrodes; and

at least one counter electrode extending over an area opposite a plurality of tracks.

In contrast to the typical arrangement using a common electrode extending over an area opposite the entire array of drive electrodes, the use of the counter electrodes can increase the contrast ratio by reducing the extent to which the tracks themselves drive the area of the liquid crystal layer opposite the tracks. In the absence of a counter electrode the tracks do cause some driving of the liquid crystal layer in accordance with the drive signal intended for the drive electrode connected to the track in question. This at least reduces the contrast ratio. It can additionally introduce artefacts into the image perceived by the viewer as result of the configuration of the tracks. However these effects are reduced by the use of the counter electrodes. In some embodiments, the counter electrodes may be driven by a counter signal chosen to maintain the adjacent area of the liquid crystal layer in the black state. In other embodiments a similar effect may be achieved by leaving the counter electrodes unconnected so that they float at an induced voltage.

A display device which is an embodiment of the present invention will now be described by way of non-limitative example with reference to the accompanying drawings, in which:

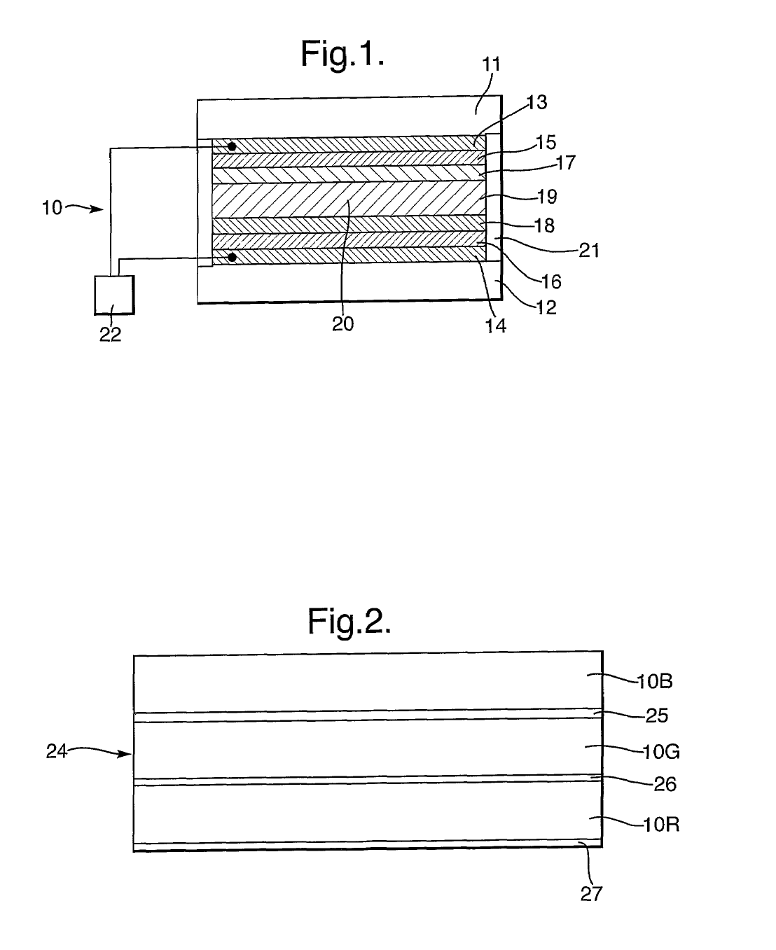

FIG. 1 is a cross-sectional view of a cell of a cholesteric liquid crystal display device;

FIG. 2 is a cross-sectional view of a cholesteric liquid crystal display device;

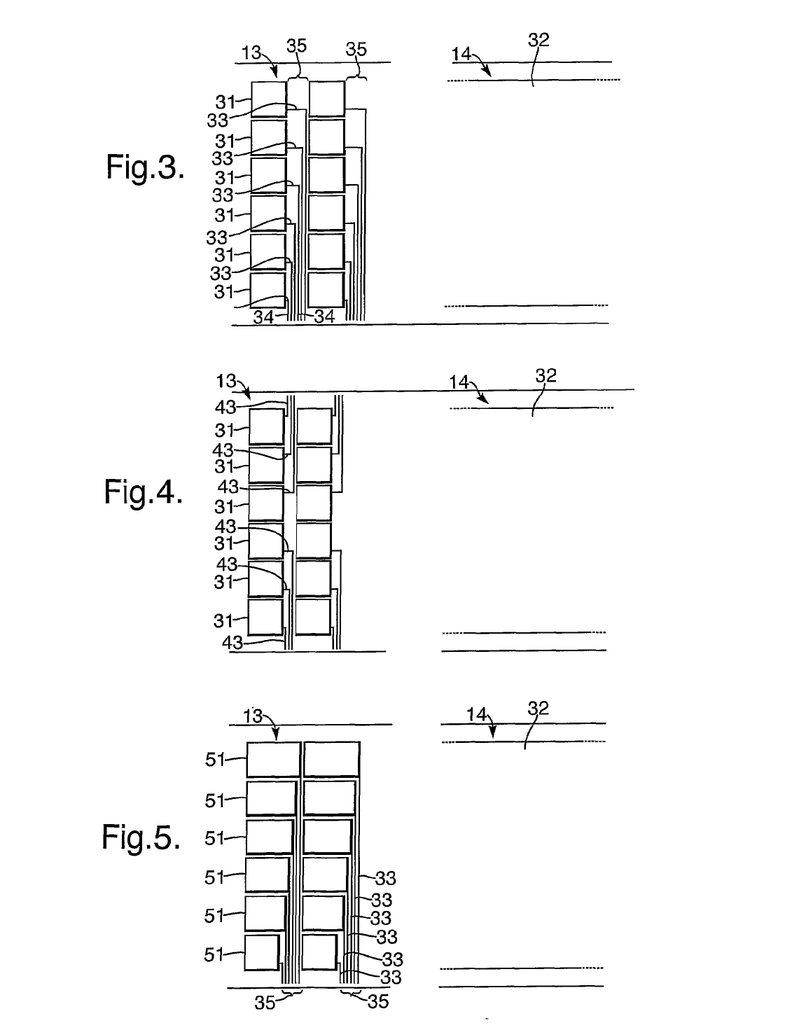

FIG. 3 shows a first pattern for the conductive layers of the cell;

FIG. 4 shows a second pattern for the conductive layers of the cell;

FIG. 5 shows a third pattern for the conductive layers of the cell;

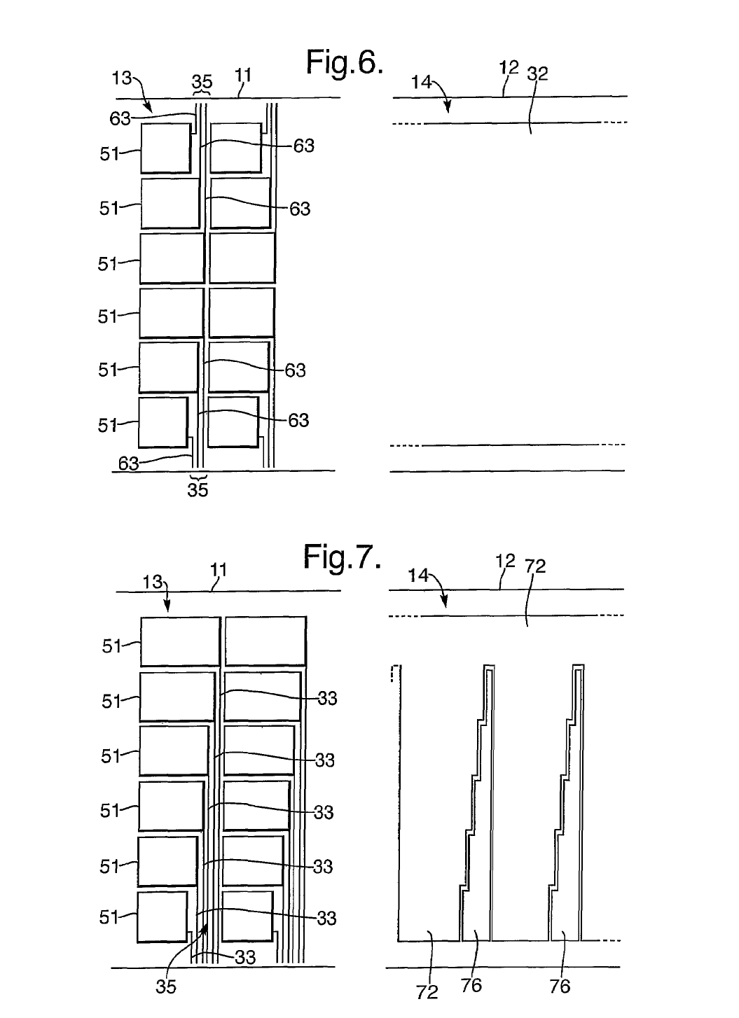

FIG. 6 shows a fourth pattern for the conductive layers of the cell;

FIG. 7 shows a fifth pattern for the conductive layers of the cell;

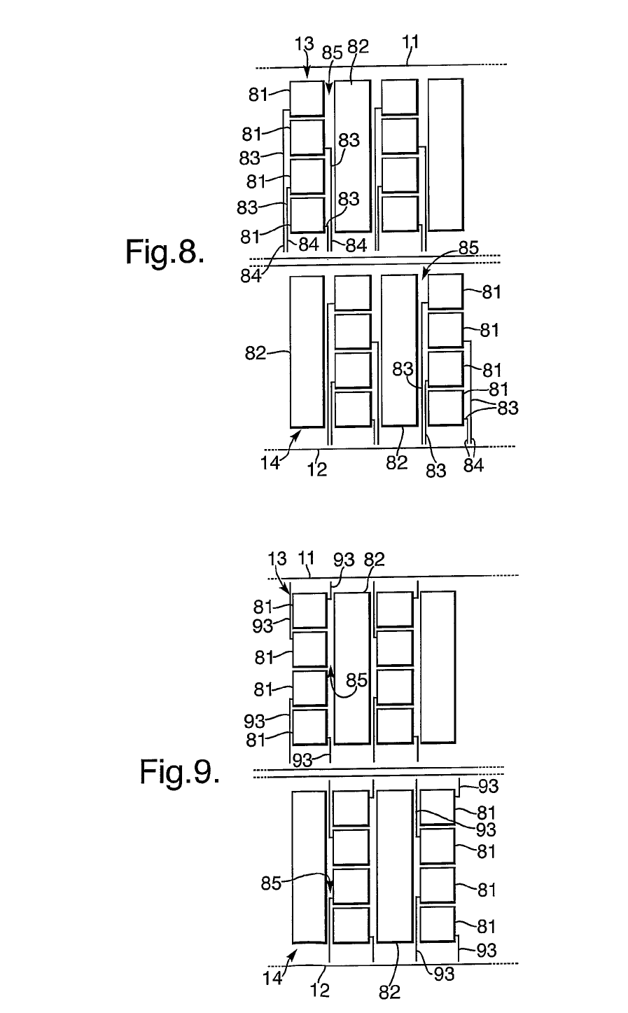

FIG. 8 shows a sixth pattern for the conductive layers of the cell; and

FIG. 9 shows a seventh pattern for the conductive layers of the cell.

There will first be described a single cell 10 which may be used in a cholesteric liquid crystal display device. The cell 10 is shown in FIG. 1 and has a layered construction, the thickness of the individual layers 11-19 being exaggerated in FIG. 1 exaggerated for clarity.

The cell 10 comprises two rigid substrates 11 and 12, which may be made of glass or preferably plastic. The substrates 11 and 12 have, on their inner facing surfaces, respective transparent conductive layers 13 and 14 formed as a layer of transparent conductive material, typically indium tin oxide. The conductive layers 13 and 14 are patterned to provide a rectangular array of directly addressable pixels, as described in more detail below.

Optionally, each conductive layers 13 and 14 is overcoated with a respective insulation layer 15 and 16, for example of silicon dioxide, or possibly plural insulation layers.

The substrates 11 and 12 define between them a cavity 20, typically having a thickness of 3 μm to 8 μm. The cavity 20 contains a liquid crystal layer 19 and is sealed by a glue seal 21 provided around the perimeter of the cavity 20. Thus the liquid crystal layer 19 is arranged between the conductive layers 13 and 14.

Each substrate 11 and 12 is further provided with a respective alignment layer 17 and 18 formed adjacent the liquid crystal layer 19, covering the respective conductive layer 13 and 14, or the insulation layer 15 and 16 if provided. The alignment layers 17 and 18 align and stabilise the liquid crystal layer 19 and are typically made of polyamide which may optionally be unidirectionally rubbed. Thus, the liquid crystal layer 19 is surface-stabilised, although it could alternatively be bulk-stabilised.

The operation of the cell 10 is as follows.

The liquid crystal layer 19 comprises cholesteric liquid crystal material. Such material has several states in which the reflectivity and transmissivity vary. These stable states are the planar state, the focal conic state and the homeotropic (pseudo nematic) state, as described in I. Sage, Liquid Crystals Applications and Uses, Editor B Bahadur, vol 3, page 301, 1992, World Scientific, which is incorporated herein by reference and the teachings of which may be applied to the present invention.

In the planar state, the liquid crystal layer 19 selectively reflects a bandwidth of light that is incident upon it. The wavelengths λ of the reflected light are given by Bragg's law, ie λ=nP, where wavelength λ of the reflected wavelength, n is the refractive index of the liquid crystal material seen by the light and P is the pitch length of the liquid crystal material. Thus in principle any colour can be reflected as a design choice by selection of the pitch length P. That being said, there are a number of further factors which determine the exact colour, as known to the skilled person. The planar state is used as the bright state of the liquid crystal layer 19.

Not all the incident light is reflected in the planar state. In a typical full colour display device 20 employing three cells 10, as described further below, the total reflectivity is typically of the order of 30%. The light not reflected by the liquid crystal layer 19 is transmitted through the liquid crystal layer 19 and subsequently absorbed by a black layer 27 described in more detail below.

In the focal conic state, the liquid crystal layer 19 is, relative to the planar state, transmissive and transmits incident light. Strictly speaking, the liquid crystal layer 19 is mildly light scattering with a small reflectance, typically of the order of 3-4%. Thus, with the black layer 27 behind the cell 10, described in more detail below, this state is perceived as black.

In the homeotropic state, the liquid crystal layer 19 is even more transmissive than in the focal conic state, typically having a reflectance of the order of 0.5-0.75%.

The focal conic and planar states are stable states which can coexist when no drive signal is applied to the liquid crystal layer 19. Furthermore the liquid crystal layer 19 can exist in stable states in which different domains of the liquid crystal material are each in a respective one of the focal conic state and the planar state. These are sometimes referred to as mixture states. In these mixture states, the liquid crystal material has a reflectance intermediate the reflectances of the focal conic and planar states. A range of such stable mixture states is possible with different mixtures of the amount of liquid crystal in each of the focal conic and planar states so that the overall reflectance of the liquid crystal material varies.

The homeotropic state is not stable and so maintenance of the homeotropic state requires application of a drive signal.

A control circuit 22 supplies a drive signal to the conductive layers 13 and 14 to apply an electric field across the liquid crystal layer 19 to effect switching between the states of the liquid crystal material and thereby to change the reflectance of the liquid crystal layer 19 for displaying an image to a viewer. This effect is described in W. Gruebel, U. Wolff and H. Kreuger, Molecular Crystals Liquid Crystals, 24, 103, 1973, which is incorporated herein by reference and the teachings of which may be applied to the present invention.

There are two alternative modes of operation of the cell 10. The cell 10 is operated in one of these two modes.

In the first mode of operation, the stable states are used, that is the planar and focal conic states, the focal conic state being used as the black state. This mode of operation has the advantage of low power consumption in that drive signals are only supplied when the liquid crystal layer 19 is required to change from the planar state to the focal conic state and vise versa. In this mode of operation, the inherent contrast ratio (the ratio of the light reflected in the white state to the black state) of an area of the liquid crystal layer 19 is typically of the order of 10:1. Grey scale may be achieved by suitable drive signals which drive the liquid crystal material into the stable mixture states having reflectances intermediate the reflectances of the focal conic and planar states, for example as disclosed in Huang et al., “Full Color (4096 Colors) Reflective Cholesteric Liquid Crystal Display”, Asia Display 1998, pp 883-885 1973, which is incorporated herein by reference and the teachings of which may be applied to the present invention.

In the second mode of operation, all the states are used, including the homeotropic state which is used as the black state. This has the advantage of increasing the contrast ratio because of the lower reflectance in the homeotropic state than in the focal conic state. In this mode of operation, the inherent contrast ratio of an area of the liquid crystal layer 19 is typically of the order of 40:1. On the other hand, as the homeotropic state is not stable and requires the drive signal to be maintained, this mode of operation consumes additional power. However, in practice the overall power consumption is relatively low as compared to equivalent types of liquid crystal display device as typical images require only a fraction of the cell 10 to be in the homeotropic state, typically of the order of 10-20% of the cell 10.

Typically, the drive signals take the form of pulses. The pulses may be of 30-50V with an AC or bipolar pulse of duration 50-100 ms to switch the liquid crystal into the homeotropic state from which there is a fast switch-off into the planar state. To maintain the homeotropic state a balanced bipolar square wave of 30-50V and 50-100 ms duration may be used. The drive signal may be one or more (often 2 to 5) pulses of 10-20V and 1-50 ms duration to switch the liquid crystal into the focal conic state. Alternatively, pulses of 30-50V with a short duration may be used. The optimisation of the drive pulses may be found experimentally for a given configuration of the cell 10 as the exact amplitude and duration depends on a number of factors such as the thickness of the liquid crystal layer 19, the dielectric anisotropy of the liquid crystal and temperature. Thus the actual drive signal may differ from the values given above although those values are suitable starting values for the optimisation process.

A display device 24 will now be described with reference to FIG. 2.

The display device 24 comprises a stack of cells 10R, 10G and 10B, each being a cell 10 of the type shown in FIG. 1 and described above. The cells 10R, 10G and 10B have respective liquid crystal layers 19 which are arranged to reflect light with colours of red, green and blue, respectively. Thus the cells 10R, 10G and 10B will thus be referred to as the red cell 10R, the green cell 10G and the blue cell 10B. Selective use of the red cell OR, the green cell 10G and the blue cell 10B allows the display of images in full colour, but in general a display device could be made with any number of cells 10, including one.

In FIG. 2, the front of the display device 24 from which side the viewer is positioned is uppermost and the rear of the display device 24 is lowermost. Thus, the order of the cells 10 from front to rear is the blue cell 10B, the green cell 10G and the red cell 10R. This order is preferred for the reasons disclosed in West and Bodnar, “Optimization of Stacks of Reflective Cholesteric Films for Full Color Displays”, Asia Display 1999 pp 20-32, although in principle any other order could be used.

The adjacent pair of cells 10R and 10G and the adjacent pair of cells 10G and 10B are each held together by respective adhesive layers 25 and 26.

The display device 24 has a black layer 27 disposed to the rear, in particular by being formed on a rear surface of the red cell 10R which is rearmost. The black layer 21 may be formed as a layer of black paint. In use, the black layer 27 absorbs any incident light which is not reflected by the cells 10R, 10G or 10B. Thus when all the cells 10R, 10G or 10B are switched into the black state, the display device appears black.

The display device 24 is similar to the type of device disclosed in WO-01/88688 which is incorporated herein by reference and the teachings of which may be applied to the present invention.

There will now be described the manner in which the conductive layers 13 and 14 are patterned to allow operation of the liquid crystal layer 19 as a rectangular array of directly addressable pixels. Several alternative patterns will be described with reference to FIGS. 3 to 9 which each show the pattern of the conductive layers 13 and 14 on the substrates 11 and 12, respectively. Each of these patterns include common elements which are given common reference numerals. For brevity a description of the common elements. In each of FIGS. 3 to 9, for clarity the drawings illustrate the pattern of the conductive layers 13 and 14 for only a limited number of lines of pixels each having only a limited number of pixels, for example six. The actual display device 24 may comprise a different number of lines of pixels, more typically 36 lines of 18 pixels or larger. Most useful display devices will have at least three or preferably at least five pixels in each dimension.

A first pattern is shown in FIG. 3. In this pattern, the first conductive layer 13 provides a rectangular array of separate drive electrodes 31 and the second conductive layer 14 provides a common electrode 32 extending over the area opposite the entire array of drive electrodes 31.

The first conductive layer 13 further provides separate tracks 33 each connected to one of the drive electrodes 31. Each track 33 extends from its respective drive electrode 31 to a position outside the array of drive electrodes 31 where the track forms a terminal 34. The control circuit 22 makes an electrical connection to each of the terminals 34. Through this connection, the control circuit 22 in use supplies a respective drive signal to each terminal 34. Thus the respective drive signals are then supplied via the tracks 33 to the respective drive electrodes 31. In this manner, each drive electrode 31 is independently receives its own drive signal and drives the area of the liquid crystal layer 19 adjacent that drive electrode 31 which area of the liquid crystal layer 19 acts as a pixel. In this manner, an array of pixels is formed in the liquid crystal layer 19 adjacent the array of drive electrodes 31. As each drive electrode 31 receives a drive signal independently, each of the pixels is directly addressable. Such direct addressing provides a number of advantages which are set out in detail above.

To accommodate the tracks 33 in the conductive layer 13, the drive electrodes 31 are arranged in lines (extending vertically in FIG. 3) with a gap 35 between each adjacent line of drive electrodes 31. The tracks 33 connected to a single line of drive electrodes 31 all extend along one of the gaps 35. All the tracks 33 from each drive electrode 31 in the line of drive electrodes 31 exit the array of drive electrodes 31 on the same side, that is lowermost in FIG. 3. As a result, all of the terminals 34 are formed on the same side of the display device 24. This has particular advantage when a plurality of identical display devices 24 are tiled to provide a larger image area because it reduces the gap needed between the individual display devices 24.

The display device 24 has a relatively large area and is intended to provide a relatively large viewing distance, for example for use outdoors or in a large public space such as a building or a transport node. As such, the pixels are of a relatively large area, for example at least 4 mm² or more preferably at least 25 mm², a typical area being of the order of 80 mm². Each of the pixels 31 is of the same area and is typically square. It has been appreciated that the use of direct addressing in the display device 24 causes a lesser reduction in the contrast ratio than would occur if direct addressing was applied to a display device of smaller size, for example as used as a computer monitor or a television. This results from the fact that the width and spacing of the tracks 33 is fixed. Accordingly for a given number of pixels along the dimension which is vertical in FIG. 3, the width of the gap 35 needed to accommodate the tracks 33 is fixed. Thus, the fill factor, which is the ratio of the total area of the pixels adjacent the drive electrodes 31 to the total viewing area of the display device 24 including the drive electrodes 31 and the gaps 35, reduces as the size of the drive electrodes 31 decreases. This means that the reduction in the contrast ratio caused by the gaps 35 reduces as the size of the drive electrodes 31 increases. Based on this effect, it has been appreciated that for the display device 24 having pixels of a relatively large area, it is still possible to achieve an acceptable contrast ratio with the use of direct addressing.

To illustrate this, Table 1 shows fill factors for two equivalent display devices of given pixel pitches, in particular (1) a display device employing passive multiplexed addressing and (2) the display device 24 employing direct addressing with the first pattern of the conductive layers 13 and 14 shown in FIG. 3. The figures in Table 1 are calculated on the basis that the width of the tracks 33 is 20 μm and that the spacing between the tracks 33 is 10 μm, which are reasonable values at the edge of production technology in passive liquid crystal display lines.

TABLE 1

| | | Fill factor | |
|---|---|---|---|
| Pixel | No. of | for (1) Passive | Fill factor |
| Pitch | Pixels | multiplexed | for (2) Direct |
| (mm) | high | addressing | addressing |
| 9 × 9 | 18 | 98.9% | 93.3% |
| 5 × 5 | 32 | 98% | 79% |

It can be seen from Table 1 that the use of direct addressing does reduce the fill factor as compared to the use of passive multiplexed addressing, but the reduction is not very large and in particular is much improved as compared to a display device having small pixels.

The fill factor reduces the actual contrast ratio of the display device 24 as a whole below the inherent contrast ratio of the liquid crystal layer 19 which might typically be of the order of 40:1 for the display device 24 used in the second mode of operation set out above.

In addition, with the first pattern of the conductive layers 13 and 14 shown in FIG. 3, a further factor which reduces the contrast ratio is the presence of the tracks 33 in the gaps 35. As the tracks 33 are subject to the drive signals supplied to the corresponding drive electrode 31, the tracks 33 drive the area of the liquid crystal layer 19 adjacent the tracks 33 in the gaps 35. The effect at any given moment depends on the nature of the image represented by the drive signals, but in general it may be considered to place the material of the liquid crystal layer 19 in a random orientation. This is usually a relatively bright state and so reduces the contrast ratio by degrading the dark area. For example, this effect may be serious where a track 33 connected to a drive electrode 31 addressing a pixel which is bright passes between other drive electrodes 31 which drives pixels which are dark.

To consider the impact of these effects on the contrast ratio, one can consider the second mode of operation of the display device 24 for which the inherent contrast ratio is 40:1 as discussed above. In comparison with an equivalent display device employing passive multiplexed addressing which has a contrast ratio of about 10:1-15:1, the display device 24 using the pattern of the conductive layers 13 and 14 shown in FIG. 3 as a contrast ratio of 14:1 due to the two effects just described. It is noted that this contrast ratio still renders the display device 24 useable in practice. However, it has been appreciated that other patterns of the conductive layers 31 and 32 may be used to improve the contrast ratio, as in the further patterns which will now be described.

A second pattern for the conductive layers 13 and 14 is shown in FIG. 4. This pattern is the same as the first pattern shown in FIG. 3 except that the tracks 33 are replaced by tracks 43 which extend in different directions. In particular, some of the tracks 43 which are connected to drive electrodes 31 along a part, preferably half, of a line of drive electrodes 31 exit the array of drive electrodes 31 on one side, for example lowermost in FIG. 4, whereas the tracks 43 connected to the remainder of the line of drive electrodes 31 exit the array of drive electrodes 31 on the opposite side thereof, for example uppermost in FIG. 4. As a result, the number of tracks 43 passing alongside one another in the gap 35 is reduced. Thus, it is possible to reduce the size of the gap 35 needed to accommodate the tracks, as compared to the first pattern of FIG. 3. This improves the fill factor and hence the contrast ratio.

A third pattern for the conductive layers 13 and 14 is shown in FIG. 5. The third pattern is the same as the first pattern illustrated in FIG. 3 except that the drive electrodes 31 of constant size are replaced by drive electrodes 51 of varying size. In particular, along a line of drive electrodes 51 from the side of on which the tracks 33 exit the array of drive electrodes, successive drive electrodes 51 have successively increasing widths as the number of tracks 33 passing through the gap 35 and connected to more distant drive electrodes 51 gets smaller. As each track 33 terminates at the drive electrode 51 to which it is connected, that drive electrode 51 has a width which is slightly greater to fill the part of the gap 35 which would otherwise be empty due to the termination of the track 33. In other words, the successive drive electrodes 51 in the line have increasing widths such that the size of the gap 35 gets thinner as the number of tracks 33 passing through the gap 35 gets smaller. By virtue of this pattern, the drive electrodes 51 and hence the pixels occupy a greater area than the pixels 51 of the first pattern of FIG. 3. In effect, the amount of space wasted within the gaps 35 is reduced. Thus, the fill factor and hence the contrast ratio are improved.

As a result of the pixels having differing areas, there is a corresponding variation in the brightness of the pixel for a given drive signal. However, it has been appreciated that this variation does not cause a significant degradation in the quality of the image received by a viewer. The physiological effect that the eye perceives brightness on a logarithmic scale means that the variation in the brightness of a pixel caused by variation in the area is of limited effect. In principle, it would be possible to vary the drive signals to each drive electrode 51 to compensate for the differing areas, but in practice this is not necessary.

A fourth pattern for the conductive layers 13 and 14 is shown in FIG. 6.

This pattern is the same as the third pattern shown in FIG. 5 except that the tracks 33 are replaced by tracks 63 which extend in different directions. In particular, some of the tracks 63 which are connected to drive electrodes 51 along a part, preferably half, of a line of drive electrodes 51 exit the array of drive electrodes 51 on one side, for example lowermost in FIG. 6, whereas the tracks 63 connected to the remainder of the line of drive electrodes 51 exit the array of drive electrodes 51 on the opposite side thereof for example uppermost in FIG. 6. As a result, the number of tracks 63 passing alongside one another in the gap 35 is reduced. Thus, it is possible to similar reduce the size of the gap 35 needed to accommodate the tracks 63. This improves the fill factor and hence the contrast ratio.

A sixth pattern of the conductive layers 13 and 14 is shown in FIG. 7. In this pattern, the first conductive layer 13 is the same as in the third pattern shown in FIG. 5. However, the second conductive layer 14 is patterned to provide a common electrode 72 and a plurality of separate counter electrodes 76. In particular, the common electrode 72 extends over an area opposite the plurality of drive electrodes 51, but not opposite the tracks 33, whereas the counter electrodes 76 each extend over an area opposite a plurality of tracks 33 which are connected to the drive electrodes 31 of a single line of drive electrodes 31. Thus, each respective counter electrodes 76 extends over an area opposite one of the gaps 35 between the lines of the electrodes 51. The counter electrodes 76 are used to increase the contrast ratio as compared to the use of a common electrode 32 extending over an area opposite the entire array of drive electrodes 51 as in the third pattern of FIG. 5. This is achieved because the counter electrodes can be used to reduce the extent to which the tracks 33 themselves drive the area of the liquid crystal layer 19 opposite the tracks 33 in the manner discussed above with reference to the first pattern of FIG. 3. This may be achieved by two alternative techniques.

The first technique of using the counter electrodes 76 is to apply counter signals to the counter electrodes 76 such that the area of the liquid crystal layer 19 between the counter electrodes 76 and the tracks 33 is driven to the black state at all times, regardless of the drive signals supplied via the tracks 33. The dark state is produced by driving the counter electrodes 76 at a voltage in the low reflectance region of the voltage-reflectance curve for the specific construction of the display device 24, which curve can be easily derived.

This driving does not have a large effect on the image perceived by a viewer when the pixels adjacent the tracks 33 are in the bright state. However, it has a dramatic effect on the image perceived by a viewer when the pixels adjacent the tracks 33 are in the black state which otherwise would have bright lines running through them reducing the contrast ratio. Accordingly, this technique improves the contrast ratio by removing such bright lines.

The improvement in the contrast ratio is illustrated in Tables 2 to 4 which each show the same set of parameters but for different patterns. Table 2 shows parameters for the first pattern of FIG. 3. Table 3 shows parameters for the third pattern of FIG. 5. Table 4 shows parameters for the fifth pattern of FIG. 7. The parameters are calculated on the basis that the black state generated in the pixels adjacent the drive electrodes 31 and 51 has a reflectance of 5% while the black state generated in the area of the liquid crystal layer 19 between the gaps 35 and the counter electrodes 76 are 20% (full white having reflectance of 30%). This figure of 20% is reasonable for the following reason. The most stable state is the bright state. If the liquid crystal layer is fully converted, the bright state would have a reflectance of 30%, but this does not occur fully and so some lower reflectance is usual. The reason it will not be fully bright is that these areas of the liquid crystal layer 19 are only covered by the tracks 33 over about ⅔ of the area of the gaps 35 and so will see a smaller voltage due to the effect of the electric field acting upon them in a parasitic manner, the voltage experienced by the material of the liquid crystal layer 19 being proportional to the distance between electrodes. In practice, a reflectance of even less than 20% might be encountered, thereby further improving the contrast ratio.

TABLE 2

| | | | | White reflectance | Black reflectance | Contact |
|---|---|---|---|---|---|---|
| Pixel | Pixel | % Fill | % Area of panel | with non optimised | with non | Ratio |
| width | Height | factor | that is not driven | pixels | optimised pixels | (CR) |
| 8.48 | 8.98 | 93.33 | 6.67 | 29.33 | 2.03 | 14.4 |

TABLE 3

| | | | | Average | Average | | |
|---|---|---|---|---|---|---|---|
| | | | | white state | black state | | |
| | | | Average | reflectance of | reflectance | CR range | Average |
| | | % Fill | fill | panel with | of panel with | with | CR With |
| Pixel | Pixel | Factor | factor | optimised | optimised | optimised | optimised |
| width | width | (Range) | (%) | pixels | pixel | pixels | pixels |
| 8.48 to | 8.98 | 93.3 to | 96.1 | 29.61 | 1.493 | 14.4 to | 20.9 |
| 8.99 | | 98.9 | | | | 31.34 | |

TABLE 4

| | | | | Average white | Average black | Range of | |
|---|---|---|---|---|---|---|---|
| | | | | reflectance | reflectance | CR with | Average |
| | | | Average | with optimised | with optimised | optimised | CR With |
| Pixel | Pixel | % Fill | fill | pixels and | pixels and | pixels and | driven |
| with | height | factor | factor | driven tracks | driven tracks | driven tracks | tracks |
| 8.48 to | 8.98 | 93.3 to | 96.1 | 29.22 | 1.10 | 21.06 to | 27.1 |
| 8.99 | | 98.9 | | | | 35.18 | |

Table 2 shows that the contrast ratio for the first pattern shown in FIG. 3 is about 14 as discussed above. Table 3 shows that the contrast ratio for the third pattern of FIG. 5, which varies along the line of drive electrode 31, with an average contrast ratio of about 21. Table 4 shows that the contrast ratio for the fifth pattern of FIG. 7 employing the counter electrodes 76 produces a further increase in the average contrast ratio to about 27. Thus, it can be seen that in this example the display device 24 has a high contrast ratio which is good for many applications.

The second technique of using the counter electrodes 76 is to apply no voltage to the counter electrodes 76 so they are left to float. In this case the counter electrodes will be a voltage induced primarily by the tracks 33. Depending on the drive signals appearing on the tracks 33, this induced voltage will be some average between zero and maximum voltage apply to the tracks 33. This maximum voltage is usually a small amount higher than the voltage (V4) required to drive the liquid crystal layer 19 into the white state. By definition, the voltage difference between the voltage induced on the counter electrode 76 and any track 33 will be less than V4. Moreover, when the voltage of one track 33 is the maximum voltage close to V4 and the voltage of another track 33 is zero, the voltage difference between the voltage induced on the counter electrode 76 and some of the tracks 33 will be less then (V4)/2 and they will switch to focal conic state, ie the black state. Statistically, after enough pulses of the drive signals, all the material of the liquid crystal layer adjacent the counter electrode will be driven to a voltage in the low reflectance region of the voltage-reflectance curve and switch to focal conic state. The chance of being driven back to the bright planer state is very low. Thus the second technique results in a similar result to the first technique but saves on the required driver units and edge connections.

A sixth pattern for the conductive layers 13 and 14 is shown in FIG. 8. In this pattern, each of the conductive layers 13 and 14 provides lines of drive electrode 81. Each drive electrode 81 is of the same size and shape. The lines of drive electrodes in each of the conductive layers 13 and 14 are spaced apart. Interposed between each adjacent lines of drive electrodes 81 is a common electrode 82 which is a single electrode having the same width (extending horizontally in FIG. 8) as the drive electrodes 81 and having a length (extending vertically in FIG. 8) extending along the entire length of the line of drive electrodes 81. There is a gap 85 between each line of drive electrodes 81 and each adjacent common electrode 82.

Although both conductive layers 13 and 14 include lines of drive electrodes 81 and common electrodes 82 having the same configuration, the lines of drive electrodes 81 are shifted between the two conductive layers 13 and 14 by an amount equal to half the pitch of the successive lines of drive electrodes 81 in a single one of the conductive layers 13 and 14. As a result, the common electrodes 82 in each conductive layer 13 and 14 are arranged opposite a respective line of drive electrodes 81 in the other one of the conductive layers 13 and 14. As the common electrodes 82 have the same width as the drive electrodes 81, the gaps 85 between each line of drive electrodes 81 and the adjacent common electrodes 82 are arranged directly opposite one another.

When the display device 24 is viewed from the front, the lines of drive electrodes 81 in both of the conductive layers 13 and 14 together form an array of drive electrodes 81 in which successive lines of the drive electrodes 81 are provided alternatively in the two conductive layers 13 and 14. The drive electrodes 81 in each conductive layer 13, 14 activate an adjacent area of the liquid crystal layer 19 to provide an array of pixels.

The conductive layers 13 and 14 further provides a plurality of tracks 83, each connected to one of the drive electrodes 81 and extending from that drive electrode 81 along one of the gaps 85 to the outside of the array of drive electrodes 81 where the tracks 83 form respective terminals 84.

All the tracks 83 exit the array of drive electrode 81 on the same side. In respect of each line of drive electrodes 81, the tracks 83 connected to a proportion, preferably a half, of the drive electrodes 81 lie on one size of the line of drive electrodes 81 (for example left in FIG. 8) and the track connected to the remaining proportion of the drive electrodes 81 lie on the other side of the line of driver electrodes 81 (for example right in FIG. 8). As shown in FIG. 8, successive drive electrodes 81 along the line have tracks 83 on alternate sides of the line of drive electrodes 81, but the tracks 83 on each side of the line of drive electrodes 81 could in general be connected to any combination of the drive electrodes 81.

As a result of the gaps 85 in the two conductive layers 13 and 14 being arranged opposite one another, the tracks 83 formed in the two conductive layers 13 and 14 arranged in the gaps 85 are also arranged opposite one another. This means that the size of the gaps 85 can be reduced as compared to the size of the gaps 35 in the first pattern of FIG. 3. This is because each gap 85, as viewed from the front of the display device 24, effectively accommodates two sets of tracks 83, one set of tracks 83 being accommodated in the gap 85 in the first conductive layer 13 and the other set of tracks 83 being accommodated in the gap 85 in the second conductive layer 84. This is achieved because of the provision of the drive electrodes 81 in lines arranged alternatively in the two conductive layers 13 and 14 rather than all in the first conductive layer 13. The effective reduction of the size of the gap 85 improves the fill factor and hence improves the contrast ratio of the display device 24 as compared to the first pattern of FIG. 3.

A seventh pattern for the conductive layers 13 and 14 is shown in FIG. 9. The seventh pattern is the same as the sixth pattern shown in FIG. 8, except that the tracks 83 extending the array of drive electrodes on the same side are replaced by tracks 93 which exit the array of driver electrodes 81 on both sides thereof. In particular, the tracks 93 connected to each drive electrode 81 along a part, preferably half, of the line of drive electrodes 81 exits the array of drive electrodes 81 on one side thereof, for example lowermost in FIG. 9, whereas the tracks 93 connected to each drive electrode 81 along the remainder of the line of drive electrodes 81 exit the array of drive electrodes 81 on the opposite side, for example uppermost in FIG. 9. As a result, the number of tracks 93 passing alongside one another in the gap 85 is reduced. Thus, it is possible to similar reduce the size of the gap 85 needed to accommodate the tracks 93 as compared to the sixth pattern of FIG. 8. This improves the fill factor and hence the contrast ratio.

In all the patterns described above, the patterns shown in the drawings are repeated over the entire display device 24. However this is not essential and in principle there could be variation across the display device 24. One example is for different patterns to be applied in different areas of the display device 24. Another example is for the drive electrodes of the outer lines of drive electrodes to be connected to tracks arranged outside the array of pixels as there is no need to route them through gaps between the adjacent lines of drive electrodes.

In all the patterns described above, the lines of drive electrodes extending vertically in the drawings could extend vertically or horizontally across the display device in its normal orientation. Although not essential, it is preferred that the lines of drive electrodes extending vertically in the drawings correspond to a dimension of the display device 24 having a lesser number of pixels as this reduces the number of tracks which must be accommodated in the gaps between the lines of pixels, thereby reducing the size of the gaps and improving the fill factor and contrast ratio.

In all the patterns described above, the patterns of the two conductive layers 13 and 14 could be swapped.

1. A liquid crystal display device including at least one cell which provides a two-dimensional array of addressable pixels having an average area of at least 4 mm² and comprises:
two substrates defining therebetween a cavity;
a layer of liquid crystal material in the cavity; and
a respective conductive layer formed on each of the substrates, at least one of the conductive layers being patterned to provide:
a two-dimensional array of separate drive electrodes each capable of driving an area of the layer of liquid crystal material adjacent the respective drive electrode as one of said pixels, and
a separate track connected to each of the separate drive electrodes and extending to a position outside the array of addressable pixels where the tracks form terminals each capable of receiving a respective drive signal to allow direct addressing of the pixel driven by the drive electrode connected to the respective terminal.

2. A liquid crystal display device according to claim 1, wherein the drive electrodes have gaps therebetween through which the tracks extend, and, across at least part of the array of drive electrodes, successive drive electrodes from the outside of the array of drive electrodes have increasing sizes such that the gaps get thinner as the number of tracks passing through) the gaps gets smaller.

3. A liquid crystal display device according to claim 1, wherein:
in respect of at least one line of drive electrodes in the array of drive electrodes, the track connected to each drive electrode in the said line of drive electrodes extends between the said line of drive electrodes and an adjacent line of drive electrodes; and
along at least part of the said line of drive electrodes, the tracks connected to the drive electrodes exit the array of drive electrodes on the same side thereof and successive drive electrodes from that side of the array of drive electrodes have successively increasing widths as the number of tracks connected to more distant drive electrodes gets smaller.

4. A liquid crystal display device according to claim 3, wherein said at least part of the said line of drive electrodes is the entire line of drive electrodes across the array of drive electrodes.

5. A liquid crystal display device according to claim 3, wherein said at least part of the said line of drive electrodes is a part of the entire said line of drive electrodes across the array of drive electrodes, and, along the remainder of the said line of drive electrodes, the tracks connected to the drive electrodes exit the array of drive electrodes on the opposite side thereof and successive drive electrodes from that opposite side of the array of drive electrodes have successively increasing widths as the number of tracks connected to more distant drive electrodes gets smaller.

6. A liquid crystal display device according to claim 3, wherein said at least one line of drive electrodes comprises every line of drive electrodes across the entire array of drive electrodes except the outer lines of electrodes.

7. A liquid crystal display device according to claim 2, wherein one of the conductive layers is patterned to provide the drive electrodes and the tracks, and the other of the conductive layers is patterned to provide at least one common electrode over an area opposite a plurality of drive electrodes.

8. A liquid crystal display device according to claim 1, wherein the two conductive layers are patterned to provide:
successive lines of the drive electrodes in the array of drive electrodes alternately in the two conductive layers; and
common electrodes in each conductive layer opposite respective lines of drive electrodes provided in the other conductive layer, the common electrodes being arranged within each conductive layer alternately with the lines of drive electrodes provided in the same conductive layer to leave gaps between the lines of drive electrodes and the adjacent common electrodes, the gaps in the two conductive layers being opposite one another; and
the tracks connected to the drive electrodes of respective lines of drive electrodes extending along the said gaps.

9. A liquid crystal display device according to claim 8, wherein, in respect of each line of drive electrodes except the outer lines of drive electrodes, the tracks connected to a proportion of the drive electrodes lie in the gaps on one side of the line of drive electrodes and the tracks connected to the remaining proportion of the drive electrodes lie on the other side of the line of drive electrodes.

10. A liquid crystal display device according to claim 9, wherein said proportions are each a half.

11. A liquid crystal display device according to claim 8, wherein, in respect of each line of drive electrodes except the outer lines of drive electrodes, the tracks connected to each drive electrode exit the array of drive electrodes on the same side thereof.

12. A liquid crystal display device according to claim 8, wherein, in respect of each line of drive electrodes in the array of drive electrodes except the outer lines of drive electrodes, the tracks connected to each drive electrode along a part of the line of drive electrodes exit the array of drive electrodes on one side thereof and the tracks connected to each drive electrode along the remainder of the line of drive electrodes exit the array of drive electrodes on the opposite side thereof.

13. A liquid crystal display device according to claim 1, wherein, in respect of at least one line of drive electrodes in the array of drive electrodes, the tracks connected to each drive electrode along a part of the line of drive electrodes extend along a gap between the said line of drive electrodes and an adjacent line of drive electrodes to exit the array of drive electrodes on the one side thereof and the tracks connected to each drive electrode along the remainder of the line of drive electrodes extend along a gap between the said line of drive electrodes and an adjacent line of drive electrodes to exit the array of drive electrodes on the opposite side thereof.

14. A liquid crystal display device according to claim 13, wherein said at least one line of drive electrodes comprises every line of drive electrodes across the entire array of drive electrodes except the outer lines.

15. A liquid crystal display device according to claim 1, wherein one of the conductive layers is patterned to provide the drive electrodes and the tracks and the other of the conductive layers is patterned to provide:
at least one common electrode extending over an area opposite a plurality of the drive electrodes; and
at least one counter electrode extending over an area opposite a plurality of tracks.

16. A liquid crystal display device according to claim 15, wherein, in respect of plural lines of drive electrodes in the array of drive electrodes, the tracks connected to each drive electrode in a line of drive electrodes extend along a gap between said line of drive electrodes and an adjacent line of drive electrodes, and a respective counter electrode is arranged over the tracks in each gap

17. A liquid crystal display device according to claim 1, wherein the liquid crystal material is cholesteric liquid crystal material.

18. A liquid crystal display device according to claim 1, wherein the array of addressable pixels have an average area of at least 25 mm².

19. A liquid crystal display device according to claim 1, wherein the array of addressable pixels is a rectangular array.

20. A liquid crystal display device including at least one cell which provides a two-dimensional array of addressable pixels and comprises:
two substrates defining therebetween a cavity;
a layer of liquid crystal material in the cavity; and
a conductive layer formed on each of the substrates, the conductive layers being patterned to provide electrodes for driving the liquid crystal material in accordance with a drive signal and tracks extending from the electrodes to a position outside the array of addressable pixels where the tracks form terminals for receiving a respective drive signal,
the electrodes including a two-dimensional array of separate drive electrodes each connected to a separate track to allow direct driving of an area of the layer of liquid crystal material adjacent the respective drive electrode as one of said pixels, whereby the pixels are directly addressable.
